(19) United States
(12) Patent Application Publication
(10) Pub. No.: US 2020/0027169 A1
(43) Pub. Date: Jan. 23, 2020

(54) BLOCKCHAIN-ENABLED DOUBLE ENTRY RECORDKEEPING SYSTEM AND METHOD OF IMPLEMENTING THE SAME

(71) Applicant: RENATO VALENCIA, MUNTINLUPA CITY (PH)

(72) Inventor: RENATO VALENCIA, MUNTINLUPA CITY (PH)

(21) Appl. No.: 16/041,740

(22) Filed: Jul. 21, 2018

(51) Int. Cl. G06Q 40/00; H04L 9/32; H04L 9/06; H04L 9/08; G06F 17/30

(52) U.S. Cl. CPC G06Q 40/12; H04L 9/3247; G06F 17/30185; H04L 9/0825; G06F 17/30206; H04L 9/0643

(57) ABSTRACT

One aspect of the invention is directed to a Blockchain-enabled double entry recordkeeping system for maintaining one or more ledger accounts of a recordkeeping entity. The system comprises a recordkeeping device which comprises a ledger account record broadcasting structure for broadcasting on a Blockchain network at least one of a digital value and a value balance, and an authorization device for qualifying the digital value as a debit or credit and creating a digital signature for a block containing the digital value and value balance. In essence, accounting books or ledgers where double entries or T-accounts or debit/credit of accounts are streamed using Blockchain technology to ensure that these immutable data streams end up in documents such as balance sheets, income statements, cash flow statements, general ledgers, and subsidiary ledgers of third parties.

### CROSS-REFERENCE TO RELATED APPLICATIONS

None

### FEDERALLY SPONSORED RESEARCH

Not Applicable

### SEQUENCE LISTING OR PROGRAM

Not Applicable

### TECHNICAL FIELD

The invention relates to double entry recordkeeping systems and in particular to a Blockchain-enabled double entry bookkeeping system and method of implementing the same that provide value balances and other transaction data which are associated with all ledger accounts of a recordkeeping entity whenever data relating to an accountable transaction is posted in the system.

### BACKGROUND ART

The Double Entry Bookkeeping System

Double entry recordkeeping or bookkeeping system reportedly goes far back as 11^{th} century AD, and oldest European record of a complete double entry system is the Messari accounts of the Republic of Genoa in 1340. Earliest extant accounting records that follow the modern double entry system in Europe come from Amatino Manucci, a Florentine merchant at the end of the 13^{th} century. Luca Pacioli, a Franciscan friar and often called the father of accounting, first codified the system in his mathematics textbook, “Summa de arithmetica, geometria, proportioni et proportionalita” published in Venice in 1494 (Double entry bookkeeping system; Wikipedia via https://en.wikipedia.org/wiki/Double entry_bookkeeping_system).

Some of the underlying principles of this double entry bookkeeping system include: (i) the accounting equation wherein Assets=Liabilities plus Equity; (ii) maintenance of book of accounts; (iii) debiting and crediting system whereby, at the end of day or period, debits and credits must balance; (iv) general ledgers and subsidiary ledgers must balance; (v) reports can be generated and these include balance sheet, income statement, cash flow, simulations, and projections, among others.

The double entry bookkeeping system has been used for centuries to account for financial and business dealings and most enterprises or entities have relied on it. Standards have been set and improved over time to protect and enhance its integrity. Such system could even be called the backbone of business or capitalism. Despite heavy reliance on double entry bookkeeping system, and despite continuing improvements on standards, every now and then, frauds occur through manipulation or “cooking of the books,” which by and large occurs through false or fake entries.

The Blockchain Network or Technology

The Blockchain technology originated from the white paper by Sakashi Nakamoto on bitcoin, a peer to peer exchange of values without a trusted party like banks or government agencies, and others, through a process now popularly known as Blockchain technology.” A Blockchain is a cryptographically secure, distributed database consisting of linked, time-stamped blocks of data such as transactions, an example of which is creation and exchange of bitcoins and other cryptocurrencies. It is based on peer to peer consensus and incentive-driven model of security with each block in a Blockchain containing a cryptographic hash of the previous block, which secures the integrity of the transaction data. It is infeasible to reverse the function to recover the original data and any change in the input data results in a completely different hash, etc.” (Bloomberg Businessweek, August 29 to Sep. 4, 2016).

The Blockchain network is characterized to be (i) public; (ii) transparent; (iii) decentralized; (iv) providing for immutable transaction; (v) controlled by no one but through peer-to peer networking; (vi) not only good for cryptocurrencies but can handle complex transactions; and (vii) as a technology that could even change the world.

Blockchain technology is still in its infancy and needs to prove itself with many start-ups (except for cryptocurrency) being piloted for viability and sustainability, and has its disadvantages as cryptocurrencies have had their share of losses, not due to Blockchain but because of the exchanges where cryptocurrencies are exchanged for fiat or real money. The process involved requires a lot of computation for miners who vie for the start of a Blockchain and continue the Blockchain. What is as a matter of fact being streamed is just data resulting in a log book relating to a transaction or transactions, and the challenge now is how to organize these data into a system easier to understand and use, especially for financial or business transactions.

### SUMMARY OF THE INVENTION

One aspect of the invention is directed to a Blockchain-enabled double entry recordkeeping system for maintaining one or more ledger accounts of a recordkeeping entity. The system comprises a recordkeeping device which comprises a ledger account record broadcasting structure for broadcasting on a Blockchain network at least one of a digital value and a value balance, and an authorization device for qualifying the digital value as a debit or credit and creating a digital signature for a block containing the digital value and value balance.

In essence, accounting books or ledgers where double entries or T-accounts or debit, credit of accounts are streamed using Blockchain technology to ensure that these immutable data streams end up in documents and/or reports such as, but not limited to, balance sheets, income statements, cash flow statements, general ledgers, and subsidiary ledgers of third parties, be it public or private entities.

The provision of enabling the double entry recordkeeping or bookkeeping system using the Blockchain network or technology ensures that the immutable data stream can now serve as trusted inputs to ledgers of Blockchain technology entities or ledgers for public or private third parties. The system can also serve as audit trail for third parties. In turn, this results in fewer frauds, if not totally eliminated, at less cost because Blockchain does not need a lot of people and bricks and mortars to operate.

### BRIEF DESCRIPTION OF THE SEVERAL VIEWS OF THE DRAWINGS

FIG. 1 is a schematic diagram of an example fully operational Blockchain-enabled double entry recordkeeping system in accordance with one or more embodiments of the invention.

FIG. 2 is a schematic diagram of example several components of the Blockchain-enabled double entry recordkeeping system in accordance with one or more embodiments of the invention.

FIG. 3 is a flow diagram of an example process for generating by the herein disclosed authorization device a signed block to be added to the herein disclosed Blockchain network in accordance with one or more embodiments of the invention.

FIG. 4 is a flow diagram of an example process for broadcasting by the herein disclosed recordkeeping device a signed block to be added to the herein disclosed Blockchain network in accordance with one or more embodiments of the invention.

FIG. 5 is a flow diagram of an example alternative process for broadcasting by the herein disclosed recordkeeping device a signed block to be added to the herein disclosed Blockchain network in accordance with one or more embodiments of the invention.

FIG. 6 is a schematic diagram of a single authorization device and a single recordkeeping device in communication with the herein disclosed Blockchain network consistent with one or more embodiments of the invention.

FIG. 6-A is a schematic diagram of multiple authorization devices and a single recordkeeping device in communication with the herein disclosed Blockchain network consistent with one or more embodiments of the invention.

FIG. 7 is an example tabular representation of a data structure of the herein disclosed general ledger for one ledger account consistent with one or more embodiments of the invention.

FIGS. 7-A and 7-C are example tabular representations of data structure of the herein disclosed control general ledger data file consistent with one or more embodiments of the invention.

FIG. 8 is a schematic diagram of example hardware components of the herein disclosed authorization device in accordance with one or more embodiments of the invention.

FIG. 9 is a schematic diagram of example hardware components of the herein disclosed recordkeeping device in accordance with one or more embodiments of the invention.

### LISTING OF REFERENCE NUMERALS

100—double entry recordkeeping system
102—Blockchain network
104—communications channel
106—recordkeeping device
106-a—recordkeeping device
106-c—recordkeeping device
106-e—recordkeeping device
106-g—recordkeeping device
108—authorization device
108-a—authorization device
108-c—authorization device
108-e—authorization device
108-g—authorization device
200—input structure
202—output structure
204—subsystem
206—control code file structure
208—database system
210—ledger account data file mgt structure
212—transaction data file mgt structure
214—transaction data recording structure
216—account record broadcasting structure
300—step: receive block
302—step: create digital signature
304—step: update fields in the block
306—step: sign block using digital signature
308—step: hash block
310—decision step: is hash unique?
312—step: transmit block to device
400—step: find previous block
402—step: create digital signature
404—step: update fields in the block
406—step: sign block using digital signature
408—step: hash block
410—decision step: is hash unique?
412—step: broadcast signed block
500—step: find previous block
502—step: create digital signature
504—step: update fields in the block
506—step: sign block using digital signature
508—step: hash block
510—decision step: is hash unique?
512—step: broadcast signed block
700—ledger file
702—control ledger file
704—control ledger file
800—microprocessor
802—transceiver
804—DSP (digital signal processor)
806—RAM (random access memory)
808—data communication module
810—audio communication module
812—other communication modules
814—VRAM (video random access memory)
816—flash memory
818—unit interface (or display)
820—ports
822—speaker
824—headphone
826—microphone
828—sensor subsystems
830—light sensor
832—vibration sensor
834—rotation sensor
836—short-range communication subsystems
838—Infrared
840—NFC (near field communication)
842—Bluetooth
902—CPU (central processing unit)
904—RAM (random access memory)
906—ROM (read-only memory)
908—electrically erasable programmable ROM
910—input/output interface
912—power conditioning element
914—security logic
916—Vpp (peak-to-peak voltage) generator
918—bus and power distribution system
920—cellular transceiver
922—Bluetooth™ transceiver
924—Wi-Fi transceiver
926—NFC transceiver
926-a—NFC transceiver antenna

### DETAILED DESCRIPTION OF THE PREFERRED EMBODIMENTS

In the following description, numerous specific details such as components, method-steps or process-steps, elements, features, and techniques, are set forth in order to provide a thorough understanding of the ensuing disclosures and how they may be practiced in particular embodiments.

However, it will be appreciated by a person skilled or having ordinary skills in the art to which the present invention belongs that the present disclosures may be practiced without these specific details. In other instances, well-known features, characteristics, methods, structures and techniques have not been shown in detail in order not to obscure an understanding of the ensuing disclosures.

References to “an embodiment,” “one embodiment,” “exemplary embodiment,” “example embodiment,” “some embodiments,” and so forth indicate that the embodiment(s) of the present disclosure so described may include a particular feature, characteristic, method, structure, or technique, but not every embodiment necessarily includes the particular feature, characteristic, method, structure, or technique. Further, repeated use of these phrases relating to one or more embodiments of the present invention do not necessarily refer to the same embodiment, although they may.

As may be used herein, unless otherwise specified, the term “entity” may refer to, by way of examples and not by way of limitation, and consistent with one or more aspects of the present invention, a legal person and/or a physical structure in an environment such as a financial institution, research facility or a commercial facility.

As may be used herein, unless otherwise specified, the terms “indicia” may refer to any form of markings that can be placed upon any record. The indicia may be visually perceptible (e.g., by using markings which are visible by unaided human eyes), readable by machine (e.g., by using barcode, quick-response code, or the like), and/or any one or more suitable combinations thereof. The indicia may alternatively be the entire document itself, or any other marking appended thereto.

The herein disclosed indicia may be an image feature data, either directly taken using an image capturing apparatus such as a stand-alone camera unit or a device-mounted camera unit (e.g., mobile phone mounted camera unit) or indirectly taken using a video recording apparatus. These image feature data which may be extracted from one or more portions/regions of any records may include, but are certainly not limited to, color histogram, shape identification, pattern identification, texture identification, dominant color identification, and/or orientation histogram corresponding to an image of the entity, or any other physical characteristic that is descriptive of the entity in part or as a whole.

As may be used herein, unless otherwise specified, the terms “unique identifiers” may refer to a string or multiple strings of letters, a string or multiple strings of numbers, a string or multiple strings of alphanumeric characters, a string or multiple strings of alphanumeric codes in any format or language, or the like. These strings of values may be generic attribute values which can be used to identify, verify, track, trace, and/or authenticate a digital record. Forming of the set of unique identifiers on the digital record, or on any one or more portions thereof, may be machine or apparatus assisted.

As may be used herein, unless otherwise specified, the terms “Blockchain network” may generally refer to “public record keeping system” and may specifically refer to combinations of hardware and software systems which provide distributed data structure in a decentralized computing framework and which support various computational functions which may include distributing computational tasks such as validating transaction ownership, verification of authenticity of an entity, and managing transaction risk from one or more computer systems to one or more other computer systems in a distributed network. These computer systems in the distributed record keeping system may also be characterized by a peer-to-peer network of computers or computer systems. Public, private, or a hybrid of public and private record keeping systems included in the distributed record keeping system may include blocks containing data which may be represented by encryptions and/or encrypted messages, linking data which are arranged to link a current block to a previous block in a chain of the blocks provided with encryptions and/or encrypted messages, data recording and tracking system for ensuring validity of the transactions, which may include the encryption, performed through the chain of the blocks with proof of work data.

Cryptography, such as by way of implementing digital signatures, may be used to protect the computational environment which characterizes the distributed record keeping system and to provide the distributed record keeping system with audit logs that are verifiable, sealable and/or immutable (or, simply, cannot be edited). By way of encrypting electronic records using such digital signatures which may include the step of convolving the encryptions and/or encrypted messages with known keys, the chronological order of the blocks in the chain can be identifiable and traceable without complexities in operation, and integrity of the data associated with any uniquely encrypted message and/or any verification-related messages can be arranged such that they are independently verifiable by each node in the distributed network on which the distributed record keeping system resides.

As may be used herein, the terms “biometric information” may refer to any information which are related to human characteristics. These biometric information may be derived from any single-modal or multi-modal biometric identification or sensing mechanisms which may involve use of camera, microphone, or other devices of the same nature or general characteristics. A biometric sensor in one instance, may include, by way of examples and not by way of limitation, face sensors for facial attribute recognition, speech sensors for speech recognition, optical measurement based sensors for iris pattern recognition, corneal pattern recognition and retinal scan, and as well as fingerprint sensors for fingerprint scan. The biometric sensor may also include palm sensors for palm vein pattern recognition, hand sensors for hand geometry recognition, and handwriting sensors for signature recognition.

It is to be understood and appreciated that biometric measurements of any of other body features of a user may also be utilized in the herein disclosed one or more aspects of the present invention. The biometric information captured by these and such other related sensors may generally correspond to the identifying characteristics of the individual human users. Put differently, these characteristics can be utilized to identify, verify and/or authenticate identity and/or personal information of individual human users. Any one or more suitable combinations of the aforementioned biometric information and/or captured biometric keys associated with these information, in part, or as a whole, or in conjunction with any of the herein disclosed indicia identifier and unique identifiers, may be utilized in one or more aspects of the present invention.

As may be used herein, unless otherwise specified, the term “node” may be a stand-alone device, a distributed device, a remotely operable device, or a cluster of distributed and decentralized devices. The node may be made operable to perform computations and as well as acquisitions of data from and/or transmission of data to another computing devices such as server devices, transaction devices, authorization or signing devices, recordkeeping or bookkeeping devices, and other hardware components.

The node may be or may include a micro-controller, a single central processing unit (CPU), a plurality of processing units, a digital signal processor (DSP), a single computing system, or a cluster of computing systems. The node may include a communication module that communicates with wired or wireless data and/or radio communication networks. The node may be operated by each participating entity in the distributed network. The participating entity operating the node may be any entity as defined herein.

As may be used herein, unless otherwise specified, the terms “communications channel” may refer to any number of communication systems which may include a plurality of the transaction devices, a plurality of the server devices or systems, a plurality of the authorization or signing devices, a plurality of recordkeeping or bookkeeping devices, and a plurality of the nodes preferably adapted for wireless communications with one another. For example, the data communications channel may refer to any number of data communications systems including one or more of the following communications networks and/or frameworks: a public or private data network, a hybrid public and private data network, a wired or wireless data network, an IP (Internet Protocol) framework, a WLAN (wireless local area network), a WWAN (wireless wide area network), a GAN (global area network), a MAN (metropolitan area network), an LTE (Long Term Evolution) network of any generation, a mobile WiMax (worldwide interoperability for microwave access) network, an enterprise intranet, the like, and/or, where feasible, any one or more suitable combinations thereof.

As may be used herein, unless otherwise specified, the terms “recordkeeping system” may generally refer to “bookkeeping system,” and may specifically refer to a collection of one or more hardware, software, combinations of hardware and software, or firmware components, and may be used to refer to an electronic computing device or devices, or one or more subsystems thereof, within which one or more sets of computer-executable instructions, which are tangibly embodied in one or more machine-readable media, may be executed by the hardware components in order to perform arithmetic operations, logical operations, timing operations, and specialized functions applicable to specific task objects and consequently produce control outputs and/or control signals associated with the present invention in accordance with one or more implementations and/or embodiments thereof.

As may be used herein, the terms “software application,” may refer to emulated application or applet, to a web-based applications, or to a mobile-based application, and may specifically refer to an executable computer software program or software application program that enables services and content associated with one or more implementations of the herein disclosed system and method. The application may be a mobile app or any other application that is executable via any one or more of client-side devices including a customer computer or authorization device, via a server, or via a network of computers. The program or programs which may constitute the application may be a self-contained software or is a component of or contained by another program or programs, any of which may be implemented by one or more hardware, software, firmware and/or cloud computing or cloud related computing resources comprising one or more infrastructure stacks and one or more infrastructure components such as application servers, file servers, DNS (domain name system) servers, directory servers, web servers, network servers, group servers, database servers, and the like.

As may be used herein, unless otherwise specified, the terms “authorization device” or “signing device” may refer to a wireless mobile or non-mobile data communication device such as a mobile phone, a smart-phone, a personal digital assistant (PDA) device, a tablet device, a phablet device, a desktop computer, a laptop computer, and the like. The authorization device or the customer computer may be connected to the herein disclosed communications channel and may access the herein disclosed server computer system (such as the herein disclosed recordkeeping device and Blockchain network) of a financial institution for performing various operations such as those which are associated with automated recordkeeping or bookkeeping system in the Blockchain network. The authorization device may be used by a human client to gain access to the herein disclosed recordkeeping or bookkeeping services of the present invention. In short, authorization of the user using his or her authorization device is required to gain access to the services of the financial institution and/or to the services provided for by the Blockchain network.

As may further be used herein, unless otherwise specified, the term “ledger” may refer to a distributed ledger providing a digital record of financial transactions and asset ownership, for instance. Structurally speaking, a distributed ledger may contain multiple block records, and each block record may include multiple transaction records and as well as transaction data, for example.

As may further be used herein, unless otherwise specified, the term “account” may refer to a card, transaction card, financial transaction card, payment card, and the like, and may also refer to any suitable transaction card, such as a credit card, a debit card, a prepaid card, a charge card, a membership card, a promotional card, a frequent flyer card, an identification card, a gift card, and the like, and may still refer to any suitable payment account such as a deposit account, bank account, credit account, and the like. As another example, the term “account” may be accessible using any device or media that may hold payment account information, such as mobile phones, smart-phones, personal digital assistants (PDAs), key fobs, personal computers such as laptop computers, and the like. The account can be used as an instrument for performing a payment type of transaction. By way of further example, the herein disclosed transaction may be peer-to-peer (P2P) type of transaction. Specifically, the herein disclosed transaction may be a P2P ledged-based transaction and/or payment system, wherein the ledger accounts may be issued by financial institutions such as banks and third party entities, for instance.

As may further be used herein, unless otherwise specified, the terms “transaction record” may refer to documentation of a set of one or more financial transactions, for instance. In this regard, block records may be herein referred to as “blocks,” and transaction records may be herein referred to as “transactions.” For a distributed ledger, multiple different nodes may add new blocks of transactions to the ledger, as may be used herein.

As may further be used herein, unless otherwise specified, the term “structure” may be given its broadest possible interpretation in accordance with pertinent patent laws. Accordingly, a claim incorporating the term “structure” shall cover all means, materials, or acts set forth herein, and all of the equivalents thereof. Further, the means, materials or acts and the equivalents thereof, shall include all those described in the summary of the invention, brief description of the drawings, detailed description of the preferred embodiments, abstract, and claims themselves.

As may further be used herein, unless otherwise specified, the term “bitcoin” may refer to the methods and apparatuses described in the 2008 paper by Satoshi Nakamoto titled “Bitcoin: A Peer-to-Peer Electronic Cash System” and the software system whose source code is found at https://github.com/bitcoin/bitcoin.

As may further be used herein, unless otherwise specified, the terms “recordkeeping device” or “bookkeeping device” may further refer to any apparatus such as a general purpose computer that is responsible for communicating with the Blockchain network and assembles and prepares a block for the herein disclosed authorization or signing device. When a block is found to be valid, it is also the device that broadcasts the block to and/or on the Blockchain network.

As may further be used herein, unless otherwise specified, the term “cleartext” may refer to the data that are either computer or human readable and that have not been subjected to encryption to obscure its contents or meaning.

As may further be used herein, unless otherwise specified, the term “cryptocurrencies” may refer to a digital currency in which encryption techniques are used to regulate the generation of units of currency and verify the transfer of funds. Many cryptocurrencies include the use of a Blockchain to provide security and prevent fraud such as double spending. Some cryptocurrencies have alternate mechanisms other than a Blockchain to provide the same security.

As may further be used herein, unless otherwise specified, the terms “suitability function” may refer to a process or method where the measurements and calculations related to a specific block are evaluated and the function determines if a block is suitable to be added to the Blockchain network taking into account the desired rate of block discovery and growth of the Blockchain. To be effective, it should be computationally infeasible to invert a suitability function, i.e., the function needs to be one-way in practical terms.

One example would be to calculate a secure cryptographic hash of a block, convert that hash to an integer value, and then compare that integer value to a range of acceptable integer values. The range of acceptable values would be encoded in the recordkeeping or bookkeeping data of the block. It is preferable that a good suitability function should also be tunable so that the frequency of acceptable and unacceptable blocks can be adjusted as needed.

As may further be used herein, unless otherwise specified, the terms “public/private key pair” may refer to the data for the related public and private cryptographic keys used in public-key cryptography, in particular those used for private key signing and public key verification of digital signatures which are well known in the art.

As may further be used herein, unless otherwise specified, the terms “authorization device” may specifically refer to a device capable of processing hashing function or application that also holds the private portion of a public/private key pair and uses that information to digitally sign the block. The block signing process sometimes uses other data including but not limited to the block itself and the corresponding public key. This authorization device, or signing device, may or may not perform the measurements and calculations related to the suitability function, and it may return all signed blocks or, alternatively, it may only return selected blocks to the recordkeeping device.

As may further be used herein, unless otherwise specified, the terms “connected to,” “connecting,” “communicating,” “in communication with,” “in operative communication with,” “interconnected,” or “interconnecting” may include direct connection/communication, indirect connection/communication and/or inferred connection/communication between devices/apparatuses/computers. The direct connection/communication may be provided through one or more hardware, software, firmware, electronic and/or electrical links between devices/apparatuses.

The indirect connection/communication may be provided through an intervening member such as a component, an element, a circuit, a module, a device, a node device, and an apparatus between or among devices/apparatuses. The inferred connection/communication, as may be used herein, may be characterized by one device/apparatus being connected to or in operative communication with another device/apparatus by inference, and may include direct and indirect connections/communications.

All the ensuing disclosures and illustrations of the preferred implementations and/or embodiments of one or more aspects of the present invention, along with one or more components, features or elements thereof, are merely representative for the purpose of sufficiently describing the manner by which the present invention may be carried out into practice in various ways other than the ones outlined in the ensuing description.

It is to be understood and appreciated, however, that the exemplary implementations used to describe how to make and use the one or more aspects of the present invention may be embodied in many alternative forms and should not be construed as limiting the scope of the appended claims in any manner, absent express recitation of those features in the appended claims. All the exemplary drawings, diagrams and illustrations accompanying the ensuing description should also not be construed as limiting the scope of the appended claims in any manner.

It is also to be understood and appreciated that the use of ordinal terms such as “first” and “second” is used herein to distinguish elements, features, components, calculations or steps from one another and should not also be construed as limiting the scope of the appended claims, and that these and such other ordinal terms that may appear in the ensuing description of the one or more aspects of the present invention are not indicative of any particular order of elements, features, calculations, components or steps to which they are attached. For example, a first element could be termed a second element. Similarly, a second element could be termed a first element. All these do not depart from the scope of the herein disclosure and its accompanying claims.

Unless the context clearly and explicitly indicates otherwise, it is also to be understood that like reference numerals refer to like elements throughout the ensuing description of the figures and/or drawings of the present disclosure, that the linking term “and/or” includes any and all combinations of one or more of the associated listed items, that the singular terms “a”, “an” and “the” are intended to also include the plural forms, and that some varying terms or terminologies of the same meaning and objective may be interchangeably used throughout the ensuing disclosure.

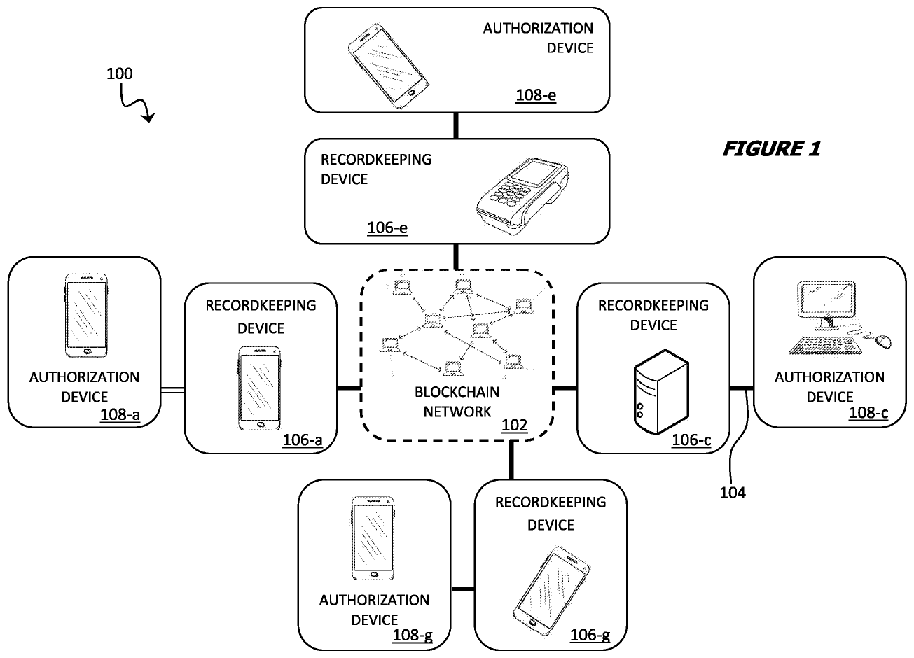

Referring now to FIG. 1, there is shown a schematic diagram of an example fully operational Blockchain-enabled double entry recordkeeping system 100 in accordance with one or more embodiments of the present invention. It is to be understood and appreciated that this is just one of many possible configurations and uses so it is important to note that the depiction in this figure is not meant to limit the scope of the present invention but to serve as an exemplary concrete illustration.

In the center of the diagram is a Blockchain network 102 that is connected to various components of the system 100 of the present invention via a communications channel 104. Two devices are of particular interest in the illustrated diagram of FIG. 1. The first device is a recordkeeping device 106-a, 106-c, 106-e, 106-g, which in an example case may be kept or maintained in and by a recordkeeping entity. The second device is an authorization device 108-a, 108-c, 108-e, 108-g. The recordkeeping device 106-a, 106-c, 106-e, 106-g and the authorization device 108-a, 108-c, 108-e, 108-g may be distinct from one another or may be the same.

By way of examples, the authorization device 108-a and the recordkeeping device 106-a may be the same and owned and operated by a single user, operator, or consumer. The authorization device 108-c and the recordkeeping device 106-c are different but may be located in and maintained by a financial institution such as a bank or other intermediary or third party payment instrument or service provider such as PayPal™ Since recordkeeping of financial data requires licensing, those who would engage in using the services of the herein disclosed system 100 have to be accredited, licensed, and/or authorized by any concerned regulatory institution providing standards, rules, and policies, and/or by the government in general.

By way of another example, the authorization device 108-e and the recordkeeping device 106-e may be used for commercial applications, wherein the authorization device 108-e may be owned and operated by a user or consumer while the recordkeeping device 106-e may be a point-of-sale (POS) system which may be located in a commercial facility such as supermarket and grocery store.

Still by way of example, the authorization device 108-g and the recordkeeping device 106-g are different and are owned and operated by different users or consumers. This may be a case of peer-to-peer (P2P) transaction, or direct transaction, between the users or consumers.

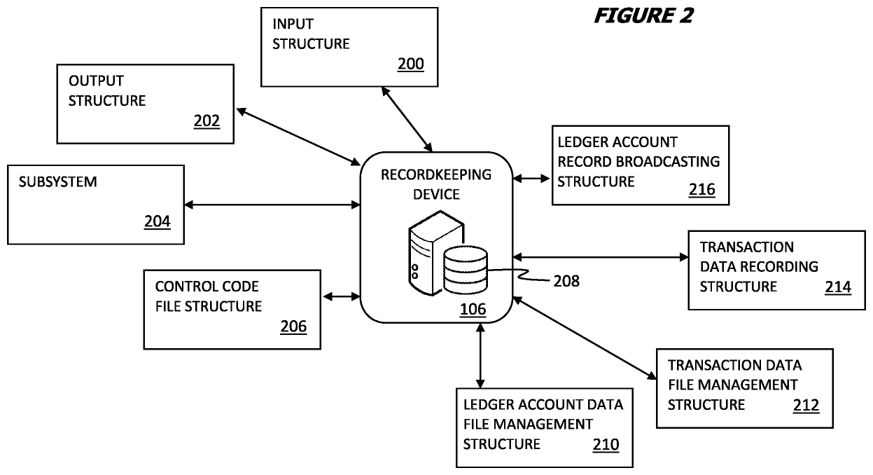

Referring to FIG. 2, there is shown a schematic diagram of example several components of the Blockchain-enabled double entry recordkeeping system or bookkeeping system generally in accordance with one or more embodiments of the present invention and more particularly in conjunction with the herein disclosed illustrations or diagrams as shown in FIGS. 1 to 9.

The Blockchain-enabled double entry recordkeeping system 100 is preferably used for maintaining one or more ledger accounts of the recordkeeping entity. The recordkeeping device, generally designated now as reference numeral 106 which represents reference numerals 106-a, 106-c, 106-e, 106-g as shown in FIG. 1, may have at least an input structure 200, an output structure 202, and a subsystem 204 that are in communication with one another through any suitable circuitries or communication lines.

The input structure 200 is preferably arranged for receiving transaction data relating to an accountable transaction affecting at least one of the one or more ledger accounts. The output structure 202 is preferably arranged for providing indicia of at least one value balance in each of the one or more ledger accounts. The subsystem 204 is preferably arranged for recording the transaction data and updating the value balance. It is to be understood and appreciated that the input structure 200, the output structure 202, and the subsystem 204 of the recordkeeping device 106 and their respective functions as may be disclosed herein may also constitute as part of the components of the herein disclosed authorization device—generally designated now as reference numeral 108 which represents reference numerals 108-a, 108-c, 108-e, 108-g.

The authorization device 108 is preferably arranged for receiving from the recordkeeping device 106 a block. Blocks are files where data pertaining to the Bitcoin network (i.e., Blockchain network 102) is permanently recorded. A block records some or all of the most recent Bitcoin (i.e., Blockchain) transactions that have not yet entered any prior blocks. Thus, a block is like a page of a ledger or record book. Each time a block is “completed,” it gives way to the next block in the Blockchain. This block is thus a permanent store of records which, once written, cannot be altered or removed thereby making all transaction related data immutable (see full technical explanation at www.investopedia.com/terms/b/block-bitcoin-block.asp). The block effectively contains the digital value and value balance as may be described herein in conjunction with the present invention.

The herein disclosed block preferably includes a plurality of fields. These fields may comprise at least (i) a recordkeeping procedure name, (ii) a first representative code for controlling creation and updating of a data file record, (iii) a second representative code for qualifying any digital value as a debit or credit, and (iv) a third representative code indicative of any document or report generated in connection with the accountable transaction. Access to these information may require biometric information of the user of the authorization device 108 and/or user of the recordkeeping device 106.

The document and/or report generated in connection with the accountable transaction may be any one of a balance sheet, an income statement, a cash flow statement, a statement of returned earnings, a statement of retained earnings, a statement of changes in equity, a statement of changes in notes, a projection report, a simulation report, a modelling report, a regulatory report, an assumption report, a sales report, a ledger file, a control general ledger file, a subsidiary ledger file, an obligation due subsidiary ledger file, a discretionary subsidiary ledger file, a temporary transaction records file, a permanent transaction records file, and the like.

The recordkeeping device 106 may also include a control code file structure 206 which immutably stores the recordkeeping procedure name, the first representative code for controlling the creation and updating of the data file record, the second representative code for qualifying the digital value as either debit or credit, and the third representative code indicative of the document generated in connection with the accountable transaction. Operations associated with the debit and/or credit should result in a balanced balance sheet in accordance with one or more embodiments and/or implementations, such as the herein disclosed computer-based system and computer-implemented method of the present invention.

By way of examples and not by way of limitation, the first representative code may correspond to or may be associated with recordkeeping procedure. The second representative code may correspond to or may be associated with credit label and its associated crediting operation or otherwise debit label and its associated debiting operation. The third representative code may correspond to or may be associated with reports generated using the herein disclosed ledgers of various types and transaction data.

The authorization device 108 is further preferably arranged for creating a digital signature which may serve as a unique identifier for the block using at least one public/private key pair. In one embodiment, a private key of the at least one public/private key pair is known only by the authorization device 108. In another embodiment, a public key of the at least one public/private key pair is known by the recordkeeping device 106. In yet another embodiment, the public/private key pair may be shared between the herein disclosed authorization device 108 and the recordkeeping device 106 for performing any desired transaction.

The authorization device 108 is further preferably arranged for updating the plurality of fields in the block for storing the digital signature. The digitally signed block created by the authorization device 108 may be transmitted to the recordkeeping device 106 via the communications channel 104. In turn, the recordkeeping device 106 may cause the plurality of fields and their associated data and the digitally signed block and their associated data to be stored in the database system 208. These data, whether they belong to the fields and/or to the blocks, and more specifically the double entry related data such as the herein disclosed debit related data and credit related data may be retrieved via data stream in real-time.

In one embodiment, the recordkeeping device 106 is arranged to generate the block including the plurality of fields. In one embodiment, the recordkeeping device 106 is arranged to create the digital signature for the block using the at least one public/private key pair. In one embodiment, the recordkeeping device 106 is arranged to update the plurality of fields in the block for storing the digital signature in the database system 208.

In addition to, or as an alternative to, the use of the herein disclosed database system 208, it is to be understood and appreciated that the process for storing any one or more of the transaction records, the block including the plurality of fields, and the digital signature may comprise putting the any one or more of the transaction records, the block including the plurality of fields, and the digital signature in one of a global data store, a local data store, a user-defined data store, the working area of any suitable application execution environment, an audit trail, a versioned store, a full-text index, a directory, a relational database, an object database, a key-pair database, a filesystem (or “file system”), and a combination thereof.

The recordkeeping device 106 may further comprise a ledger account data file management structure 210, a transaction data file management structure 212, a transaction data recording structure 214, and a ledger account record broadcasting structure 216.

The ledger account data file management structure 210 may be arranged for storing an account record corresponding to at least one of the one or more ledger accounts. The account record may include a value balance, the first representative code from a selected accounting control record of the accounting control records, and the second representative code from the selected accounting control record for qualifying the value balance.

The transaction data file management structure 212 may be arranged for storing a transaction record relating to the accountable transaction. The transaction record may include at least the first representative code from the selected accounting control record, the digital value, the second representative code from the selected accounting control record for qualifying the digital value, and the third representative code from the selected accounting control record.

The transaction data recording structure 214 may be arranged for transferring the transaction data including the digital value from the input structure and the first, second, and third representative codes from the selected accounting control record to a selected transaction record in the transaction data file structure. The digital value, by way of non-limiting examples, may correspond to fiat currency, any digital currency, cryptocurrency such as Bitcoin and Litecoin, precious metals, any unit of trading, and the like.

The ledger account record broadcasting structure 216, responsive to the third representative code, may be arranged for broadcasting at least one of the digital value and value balance from the selected transaction record to the account record for the ledger account affected by the accountable transaction.

In one embodiment, the authorization device 108 may further comprise separate ledger account data file management structure 210, transaction data file management structure 212, transaction data recording structure 214, and ledger account record broadcasting structure 216. Put differently, the authorization device 108 and the recordkeeping device 106 may share resources with one another.

It is on the Blockchain network 102 where the at least one of the digital value and value balance are broadcasted, published, and/or posted. The Blockchain network 102 may comprise a plurality of the recordkeeping devices 106, a plurality of the authorization devices 108, and a plurality of the blocks. The blocks of the plurality of the blocks are associated with or linked to one another and wherein each one of the blocks contains the digital signature from any of the authorization device 108 and the recordkeeping device 106.

The Blockchain network 102 may also comprise a preselected plurality of additional authorization devices 108. Each additional authorization device 108 of the preselected plurality of additional authorization devices 108 may be configured to perform functions of the herein disclosed authorization device 108.

In a preferred embodiment, at least one of the one or more ledger accounts and the transaction data can be maintained in at least one of the recordkeeping device 106, the authorization device 108, and the Blockchain network 102. Various authorized nodes can access these immutable transaction data for verification purposes. Any suitable mobile-based or web-based software application may be developed to access such data.

The system 100 may also comprise one or more decision support technologies such as, but certainly not limited to, business intelligence, artificial intelligence, machine learning, data mining, applied statistics, link analysis, mapping, visualization, analytics, predictive analytics, point-of-impact analytics, ratios, trends, Big Data, Decision Support Systems, neural networks, and enterprise resource management.

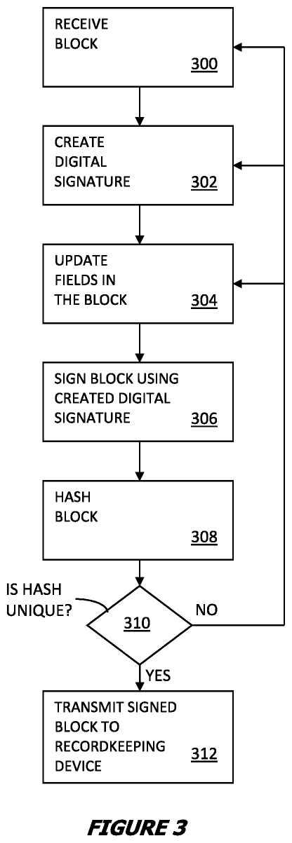

Referring to FIG. 3, there is shown a flow diagram of an example process for generating by the herein disclosed authorization device 108 the signed block to be added to the herein disclosed Blockchain network 102 in accordance with one or more embodiments of the present invention.

The example process illustrated in FIG. 3 may commence by receiving the herein disclosed block (step 300), continue by creating the herein disclosed digital signature (step 302), updating the herein disclosed fields in the block (step 304), signing the block using the created digital signature (step 306), hashing the block (step 308), and then transmitting the block to the recordkeeping device 106 (step 312) if the hash is unique (as determined in decision step 310).

If the hash is not unique, the process illustrated through the flow diagram of FIG. 3 may move back to any of the previous step 300 for receiving the block, previous step 302 for creating the digital signature, and previous step 304 for updating the fields in the block.

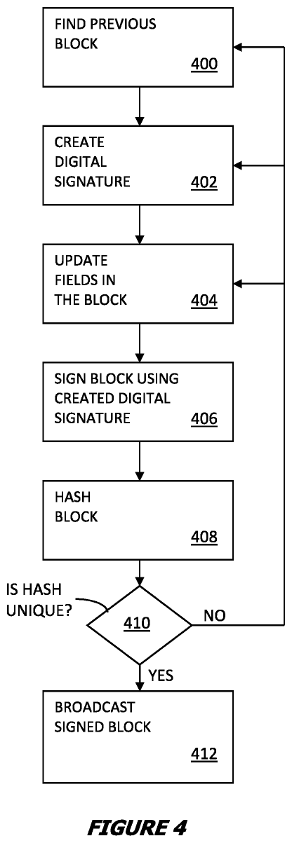

Referring to FIG. 4, there is shown a flow diagram of an example process for broadcasting by the herein disclosed recordkeeping device 106 the herein disclosed signed block to be added to the herein disclosed Blockchain network 102 in accordance with one or more embodiments of the present invention.

The example process illustrated in FIG. 4 may commence by finding a previous block (step 400), continue by creating digital signature (step 402), updating the fields in the block (step 404), signing the block using the created digital signature (step 406), hashing the block (step 408), and then broadcasting the signed block (step 412) if the hash is unique (as determined in decision step 410).

If the hash is not unique, the process illustrated through the flow diagram of FIG. 4 may move back to any of the previous step 400 for finding the previous block, previous step 402 for creating the digital signature, and previous step 404 for updating the fields in the block.

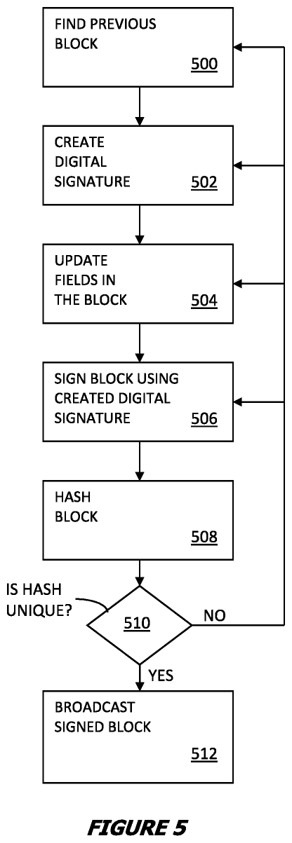

Referring to FIG. 5, there is shown a flow diagram of an example alternative process for broadcasting by the herein disclosed recordkeeping device 106 the herein disclosed signed block to be added to the herein disclosed Blockchain network 102 in accordance with one or more embodiments of the present invention.

The example process illustrated in FIG. 5 may commence by finding a previous block (step 500), continue by creating digital signature (step 502), updating the fields in the block (step 504), signing the block using the created digital signature (step 506), hashing the block (step 508), and then broadcasting the signed block (step 512) if the hash is unique (as determined in decision step 510).

If the hash is not unique, distinct from the process illustrated through the flow diagram of FIG. 4, the process illustrated through the flow diagram of FIG. 5 may move back to any of the previous step 500 for finding the previous block, previous step 502 for creating the digital signature, previous step 504 for updating the fields in the block, and previous step 506 for signing the block using the created digital signature.

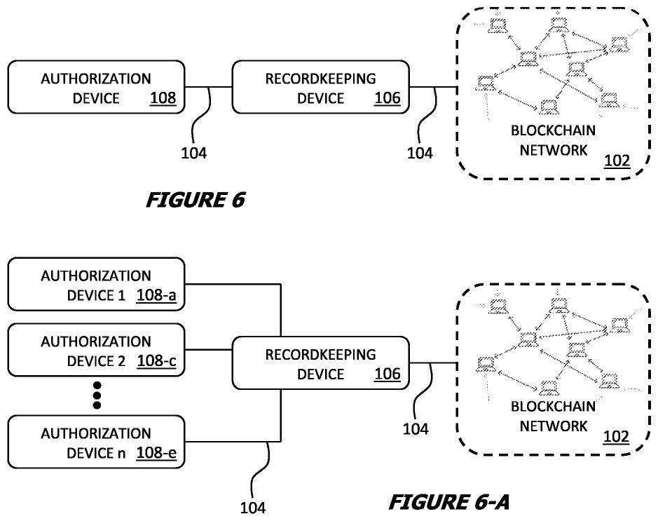

Referring to FIG. 6, there is shown a schematic diagram of a single authorization device 108 and a single recordkeeping device 106 in communication with the herein disclosed Blockchain network 102 via the communications channel 104 consistent with one or more embodiments of the present invention. The tasks, process or routine of determining the contents of the herein disclosed block and signing the same block are separated between two processing units, namely, the authorization device 108 and the recordkeeping device 106. In an alternative embodiment, these processing units of the authorization device 108 and the recordkeeping device 106 may be one and the same entity, but the figures are so arranged to treat them as separate for the purpose of illustration.

The authorization device 108, which may also be regarded as a signing device 108, preferably contains the associated data for one or more private and public key pairs needed to sign the herein disclosed generated block. It is in this specific example location where the “sign block” (steps 306, 406, 506) may be conveniently performed.

In one embodiment the private key of the public/private key pair never leaves authorization device 108 and hence only exists within the hardware and/or software components of the authorization device 108.

In another embodiment, the key can be removed from the authorization device 108 in an encrypted backup or in cleartext. In some embodiments, and by way of example and not by way of limitation, the public key of the public/private key pair can be exported and/or extracted from the authorization device 108 as part of the mined block or separate from the mined block. Miners can have access to these broadcasted blocks.

In one embodiment, the authorization device 108 may be responsible for assessing the suitability of a particular block using any appropriate suitability function or application which is known in the art.

In another embodiment, the recordkeeping device 106 may be responsible for assessing the validity of one or more blocks. In some non-limiting embodiments, the recordkeeping device 106 may be responsible for all of the other steps in the process of mining a block such that it is not responsible for signing the block.

In one embodiment, the recordkeeping device 106 is responsible for determining the suitability of a particular block. In another embodiment, the recordkeeping device 106 may not be responsible for determining the suitability of a particular block because the authorization device 108 is the one configured to be responsible for that. The recordkeeping device 106 may represent several devices that work together to fulfil its functions.

The communications channel 104 between authorization device 108 and recordkeeping device 106 can be a variety of mechanisms. In one embodiment, the authorization device 108 may be connected by the communications channel 104 to the computer via a USB connection (or similar external connection) and the authorization device 108 appears as a USB device (or similar external device) to recordkeeping device 106.

In another embodiment, the authorization device 108 may be integrated directly into any suitable computing device and communicates by communications channel 104 with the CPU via the PCI bus or any other specific on-device connection.

In another embodiment, the authorization device 108 may be integrated directly into the CPU of the recordkeeping device 106 by the communications channel 104 via a means like a trusted execution environment. In another embodiment, the authorization device 108 and the recordkeeping device 106 communicate by the communications channels 104 via any appropriate computer network such as the Internet.

The authorization device 108 could be other computing devices such as a general-purpose computer or a hardware security module. In another embodiment, the authorization device 108 and recordkeeping device 106 are one and the same. In another embodiment, the authorization device 108 and recordkeeping device 106 are different.

The Blockchain network 102 represents the collection of the generated blocks. In one embodiment, the Blockchain network 102 is a peer-to-peer network where the recordkeeping device 106 is a peer on the same network. In another embodiment, the Blockchain network 102 could be an immutable write-only file collecting the ultimate output of the mining process. The exact construction of this network may be manipulated to achieve the purpose and functions of the present invention.

In one embodiment, the communications channel 104 between the recordkeeping device 106 and the Blockchain network 102 is a traditional internet connection to a peer-to-peer network sharing information about the blocks, items to be stored as digital values, and additional information.

In another embodiment, the Blockchain network 102 is a storage device such as a hard disk and all information that would be announced, posted, and/or broadcasted to the Blockchain or read from the network would be written to or read from the disk. In this embodiment, the broadcasting to and/or on the Blockchain network 102 of the herein disclosed block may consist of writing the block to the disk. In another embodiment, the Blockchain network 102 may consist of a combination of these two embodiments. The specific communications channel 104 to the Blockchain network 102 may be manipulated to achieve the purpose and functions of the present invention.

Referring to FIG. 6-A, there is shown a schematic diagram of multiple authorization devices 108-a, 108-c, 108-e and a single recordkeeping device 106 in communication with the herein disclosed Blockchain network 102 via the communications channel 104, consistent with one or more embodiments of the present invention.

In FIG. 6-A, it is illustrated that the recordkeeping device 106 may be attached to multiple authorization devices 108-a, 108-c, 108-e. In this regard, the recordkeeping device 106 may be responsible for ensuring that each authorization device 108 is provided an appropriate amount of tasks, processes, or routines.

If each authorization device 108 has a unique key pair then whenever an authorization device 108 is presented and/or provided a block to sign that is otherwise identical to a block that another authorization devices 108-a, 108-c, 108-e is signing a different result block can be generated because the private keys differ.

In another embodiment, the authorization devices 108-a, 108-c, 108-e may share a key. In that case, the recordkeeping device 106 may be responsible for ensuring that each authorization device 108 has unique task, process, or routine to perform, often by providing only a single nonce (or an arbitrary number that can be used just once) to each authorization device 108.

In another embodiment, the uniqueness of the keys cannot be guaranteed, as some authorization devices 108-a, 108-c, 108-e may or may not share authorization and/or signing keys. In that case, the recordkeeping device 106 may treat all authorization devices 108-a, 108-c, 108-e as though they may share a key and assign unique blocks to each authorization device 108.

In some embodiments, the recordkeeping device 106 may be responsible for picking which blocks from among the authorization devices 108-a, 108-c, 108-e to use when multiple blocks that pass the suitability function are presented to recordkeeping device 106. Any suitable algorithms could be used in this case. In one case, it could be to pick the most suitable block. In another case, the least used block from among the authorization devices 108-a, 108-c, 108-e could be used. In another case, a round robin or random selection among the blocks could be suitably made.

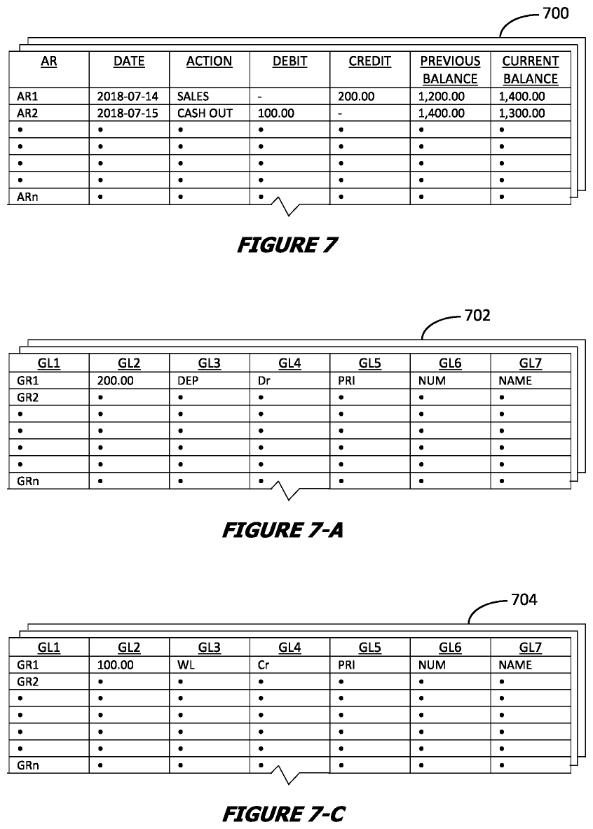

Referring to FIG. 7, there is shown an example tabular representation of a data structure of the herein disclosed general ledger for one ledger account consistent with one or more embodiments of the present invention. A graphic representation of a general ledger account or “T-account” is herein described for the purpose of understanding the underlying principles of the present invention.

The ledger file 700 may be a result of a debit/credit type of financial transaction which is well known in the financial industry.

Referring to FIGS. 7-A and 7-C, there are shown example tabular representations of data structure of the herein disclosed control general ledger data file consistent with one or more embodiments of the present invention.

Each of the control general ledger files 702, 704 includes seven data fields, GL1-GL7, for each account record stored therein. In field GL1, there is stored a record label which uniquely identifies each account record within the control general ledger file 702, 704. In practice the record label is an integer or a combination of alphanumeric characters.

Field GL2 stores a digital value which represents the value balance of the ledger account corresponding to the account record.

Field GL3 stores a transaction posting authorization code which designates the type of data in the record and controls how the value balance in field GL2 can be updated and by what recordkeeping procedures it can be updated.

As fully described herein, a recordkeeping or bookkeeping job is a procedure that can be defined in any computer program for reading data from and/or writing data to one or more data files in a manner consistent with accounting rules and policies defined in one or more accounting control tables.

A debit/credit descriptor is stored in field GL4 and provides an indication of whether the value balance in field GL2 is expected to be a debit balance, a credit balance, or zero.

Field GL5 stores a record pointer which is the record label from the permanent transaction records file of the last permanent transaction record from which the value balance in field GL2 was updated. In other words, the datum in field GL5 points to the last transaction which resulted in a change in the value balance stored in the account record.

A user defined, unique account code is stored in field GL6 and the account name corresponding to the unique account code is stored in field GL7.

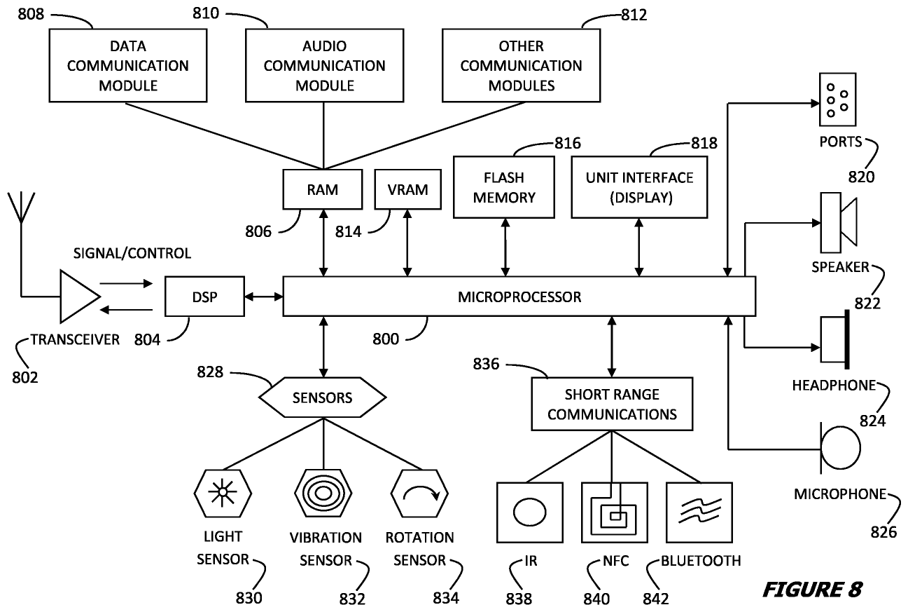

Referring to FIG. 8, there is shown a schematic diagram of example hardware components of the herein disclosed authorization device 108 in accordance with one or more embodiments of the present invention.

As illustrated in FIG. 8, the example hardware architecture of the authorization device 108, which may be a mobile device, include core system resources such as a microprocessor 800, a transceiver 802, a DSP (digital signal processor) 804, a RAM (random access memory) 806 on and from which data communication module 808, audio communication module 810, and other communication modules 812 may be stored and executed, respectively, a VRAM (video random access memory) 814, a flash memory 816, and a unit interface (or display) 818.

As illustrated, the hardware architecture of the authorization device 108 may also include I/O subsystems such as ports 820, speaker 822, headphone 824, and microphone 826, sensor subsystems 828 such as light sensor 830, vibration sensor 832, and rotation sensor 834, and short-range communication subsystems 836 such as Infrared 838, NFC (near field communication) 840, and Bluetooth 842. These and other possible components of the authorization device 108 of the system 100 illustrated in FIG. 1 may communicate with one another through one or more system buses and appropriate circuitries.

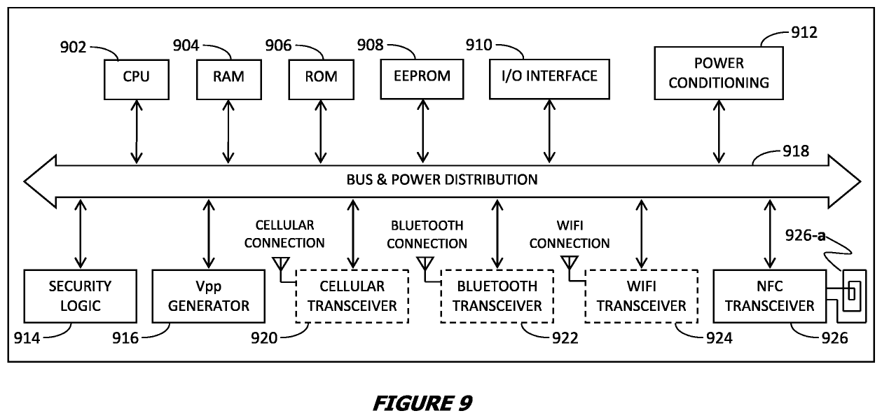

Referring to FIG. 9, there is shown a schematic diagram of example hardware components of the herein disclosed recordkeeping device 106 in accordance with one or more embodiments of the present invention. The example hardware components of the herein disclosed recordkeeping device 106 may be in the form of embedded circuitries and/or integrated circuits.

The components of the recordkeeping device 106 may include a CPU (central processing unit) 902, a RAM (random access memory) 904, a ROM (read-only memory) 906, an EEPROM (electrically erasable programmable read-only memory) 908, and an input/output interface 910.

The components of the recordkeeping device 106 may include also include a power conditioning element 912, a security logic 914, and a Vpp (peak-to-peak voltage) generator 916. These exemplary components of the recordkeeping device 106 may interact or communicate with one another through a bus and power distribution system 918. The recordkeeping device 106 may also include cellular transceiver 920, Bluetooth™ transceiver 922, Wi-Fi transceiver 924, and NFC transceiver 926 with antenna 926-a. In this respect, the recordkeeping device 106 may also facilitate NFC-based communications dependently or independently of the authorization device 108 of the system 100 illustrated in FIG. 1 and may receive incoming electronic transactions from other electronic devices or computer systems.

In another aspect of the present invention, there is disclosed a method of implementing Blockchain-enabled recordkeeping system 100.

In the Blockchain-enabled double entry recordkeeping system 100 for maintaining one or more ledger accounts of the recordkeeping entity comprising at least one recordkeeping device 106 having the input structure 200 for receiving transaction data relating to an accountable transaction affecting at least one of the one or more ledger accounts, the output structure 202 for providing indicia of at least one value balance in each of the one or more ledger accounts, and the subsystem 204 for recording the transaction data and updating the at least one balance, there is disclosed herein a method of implementing the Blockchain-enabled double entry recordkeeping system 100 that comprises the ensuing steps.

The first step of the method aspect of the present invention is characterized by receiving, by at least one authorization device 108, from the recordkeeping device 106 the block, the block including a plurality of fields comprising least a recordkeeping procedure name, a first representative code for controlling creation and updating of a data file record, a second representative code for qualifying a digital value as a debit or credit, and a third representative code indicative of a document generated in connection with the accountable transaction immutably stored by a control code file structure 206 of the at least one recordkeeping device 106.

The second step of the method aspect of the present invention is characterized by creating, by the at least one authorization device 108, the digital signature for the block using at least one public/private key pair wherein a private key of the at least one public/private key pair is known only by the authorization device 108, and a public key of the at least one public/private key pair is known by the recordkeeping device 106.

The third step of the method aspect of the present invention is characterized by updating, by the at least one authorization device 108, the plurality of fields in the block for storing the digital signature.

The fourth step of the method aspect of the present invention is characterized by storing, by the ledger account data file management structure 210 of the recordkeeping device 106, the account record corresponding to at least one of the one or more ledger accounts, the account record including the at least one value balance, the first representative code from the selected accounting control record of the accounting control records, and the second representative code from the selected accounting control record for qualifying the at least one value balance.

The fifth step of the method aspect of the present invention is characterized by storing, by the transaction data file management structure 212 of the recordkeeping device 106, a transaction record relating to the accountable transaction, the transaction record including at least the first representative code from the selected accounting control record, the digital value, the second representative code from the selected accounting control record for qualifying the digital value, and the third representative code from the selected accounting control record.

The sixth step of the method aspect of the present invention is characterized by transferring, by the transaction data recording structure 214 of the recordkeeping device 106, the transaction data including the digital value from the input structure and the first, second, and third representative codes from the selected accounting control record to the selected transaction record in the transaction data file structure.

The seventh step of the method aspect of the present invention is characterized by broadcasting, by a ledger account record broadcasting structure 216 of the recordkeeping device 106, responsive to the third representative code, at least one of the digital value and the at least one value balance from the selected transaction record to the account record for the ledger account affected by the accountable transaction.

In the method aspect of the present invention, the at least one of the digital value and the at least one value balance are broadcasted on the Blockchain network 102.

In the method aspect of the present invention, the Blockchain network 102 comprises a plurality of the recordkeeping devices 106, a plurality of the authorization devices 108, and a plurality of the blocks and their associated content.

In the method aspect of the present invention, the blocks of the plurality of the blocks are associated with one another.

In the method aspect of the present invention, each one of the blocks contains the digital signature from the authorization device 108.

In the method aspect of the present invention, the at least one of the one or more ledger accounts and the transaction data can be maintained in at least one of the recordkeeping device 106, the authorization device 108, and the Blockchain network 102.

In the method aspect of the present invention, the recordkeeping device 106 is a bookkeeping device while the authorization device 108 is a signing device. The recordkeeping device 106 and the authorization device 108 may be distinct from one another but they may also be the same.

In the method aspect of the present invention, the document and/or report generated in connection with the accountable transaction is any one of a balance sheet, an income statement, a cash flow statement, a statement of returned earnings, a statement of retained earnings, a statement of changes in equity, a statement of changes in notes, a projection report, a simulation report, a modelling report, a regulatory report, an assumption report, a sales report, a ledger file, a control general ledger file, a subsidiary ledger file, an obligation due subsidiary ledger file, a discretionary subsidiary ledger file, a temporary transaction records file, and a permanent transaction records file.

In the method aspect of the present invention, the authorization device 108 further comprises the ledger account data file management structure 210, the transaction data file management structure 212, the transaction data recording structure 214, and the ledger account record broadcasting structure 216.

In the method aspect of the present invention, the recordkeeping device 106 may be arranged to generate the block including the plurality of fields, create the digital signature for the block using the at least one public/private key pair, and update the plurality of fields in the block for storing the digital signature.

In the method aspect of the present invention, the Blockchain network 102 may further comprise a preselected plurality of additional authorization devices 108, wherein each additional authorization device 108 of the preselected plurality of additional authorization devices 108 performs functions of the authorization device 108.

The method aspect of the present invention may further comprise one or more decision support technologies such as, but not limited to, business intelligence, artificial intelligence, machine learning, data mining, applied statistics, link analysis, mapping, visualization, analytics, predictive analytics, point-of-impact analytics, ratios, trends, Big Data, Decision Support Systems, neural networks, and enterprise resource management.

In the method aspect of the present invention, the step of storing any one or more of the transaction record, the block including the plurality of fields, and the digital signature comprises the step of putting the any one or more of the transaction record, the block including the plurality of fields, and the digital signature in one of a global data store, a local data store, a user-defined data store, the working area of an application execution environment, an audit trail, a versioned store, a full-text index, a directory, a relational database, an object database, a key-pair database, a filesystem (or also known as “file system”), and a combination thereof.

While the present invention has been described with respect to a limited number of implementations, those skilled in the art, having benefit of this disclosure, will appreciate that other implementations can be devised which do not depart from the scope of the present invention as disclosed herein.

1. A Blockchain-enabled double entry recordkeeping system for maintaining one or more ledger accounts of a recordkeeping entity comprising:
at least one recordkeeping device having
an input structure for receiving transaction data relating to an accountable transaction affecting at least one of the one or more ledger accounts,
an output structure for providing indicia of at least one value balance in each of the one or more ledger accounts, and
a subsystem for recording the transaction data and updating the at least one balance;
at least one authorization device for
receiving from the recordkeeping device a block, the block including a plurality of fields comprising least a recordkeeping procedure name, a first representative code for controlling creation and updating of a data file record, a second representative code for qualifying a digital value as a debit or credit, and a third representative code indicative of a document generated in connection with the accountable transaction immutably stored by a control code file structure of the at least one recordkeeping device,
creating a digital signature for the block using at least one public/private key pair wherein a private key of the at least one public/private key pair is known only by the authorization device, and a public key of the at least one public/private key pair is known by the recordkeeping device, and
updating the plurality of fields in the block for storing the digital signature,
wherein the recordkeeping device further comprises
ledger account data file management structure for storing an account record corresponding to at least one of the one or more ledger accounts, the account record including the at least one value balance, the first representative code from a selected accounting control record of the accounting control records, and the second representative code from the selected accounting control record for qualifying the at least one value balance,
transaction data file management structure for storing a transaction record relating to the accountable transaction, the transaction record including at least the first representative code from the selected accounting control record, a digital value, the second representative code from the selected accounting control record for qualifying the digital value, and the third representative code from the selected accounting control record,
transaction data recording structure for transferring the transaction data including the digital value from the input structure and the first, second, and third representative codes from the selected accounting control record to a selected transaction record in the transaction data file structure, and
ledger account record broadcasting structure responsive to the third representative code for broadcasting at least one of the digital value and the at least one value balance from the selected transaction record to the account record for the ledger account affected by the accountable transaction; and
a Blockchain network on which the at least one of the digital value and the at least one value balance are broadcasted and comprising a plurality of the recordkeeping devices, a plurality of the authorization devices, and a plurality of the blocks, wherein the blocks of the plurality of the blocks are associated with one another and wherein each one of the blocks contains the digital signature from the authorization device,
wherein at least one of the one or more ledger accounts and the transaction data can be maintained in at least one of the recordkeeping device, the authorization device, and the Blockchain network.

2. The system according to claim 1, wherein the recordkeeping device is a bookkeeping device.

3. The system according to claim 1, wherein the authorization device is a signing device.

4. The system according to claim 1, wherein the recordkeeping device and the authorization device are distinct from one another.

5. The system according to claim 1 wherein the recordkeeping device and the authorization device are the same.

6. The system according to claim 1, wherein the document generated in connection with the accountable transaction is any one of a balance sheet, an income statement, a cash flow statement, a statement of returned earnings, a statement of retained earnings, a statement of changes in equity, a statement of changes in notes, a projection report, a simulation report, a modelling report, a regulatory report, an assumption report, a sales report, a ledger file, a control general ledger file, a subsidiary ledger file, an obligation due subsidiary ledger file, a discretionary subsidiary ledger file, a temporary transaction records file, and a permanent transaction records file.

7. The system according to claim 1, wherein the authorization device further comprises the ledger account data file management structure, the transaction data file management structure, the transaction data recording structure, and the ledger account record broadcasting structure.

8. The system according to claim 1, wherein the recordkeeping device is arranged to generate the block including the plurality of fields, create the digital signature for the block using the at least one public/private key pair, and update the plurality of fields in the block for storing the digital signature.

9. The system according to claim 1, wherein the Blockchain network further comprises a preselected plurality of additional authorization devices, wherein each additional authorization device of the preselected plurality of additional authorization devices performs functions of the authorization device.

10. The system according to claim 1, further comprising one or more decision support technologies.

11. The system according to claim 10, wherein the one or more decision support technologies include business intelligence, artificial intelligence, machine learning, data mining, applied statistics, link analysis, mapping, visualization, analytics, predictive analytics, point-of-impact analytics, ratios, trends, Big Data, Decision Support Systems, neural networks, and enterprise resource management.

12. The system according to claim 1, wherein storing any one or more of the transaction record, the block including the plurality of fields, and the digital signature comprises putting the any one or more of the transaction record, the block including the plurality of fields, and the digital signature in one of a global data store, a local data store, a user-defined data store, the working area of an application execution environment, an audit trail, a versioned store, a full-text index, a directory, a relational database, an object database, a key-pair database, a filesystem, and a combination thereof.

13. In a Blockchain-enabled double entry recordkeeping system for maintaining one or more ledger accounts of a recordkeeping entity comprising at least one recordkeeping device having an input structure for receiving transaction data relating to an accountable transaction affecting at least one of the one or more ledger accounts, an output structure for providing indicia of at least one value balance in each of the one or more ledger accounts, and a subsystem for recording the transaction data and updating the at least one balance, a method of implementing the Blockchain-enabled double entry recordkeeping system comprising the steps of:
receiving, by at least one authorization device, from the recordkeeping device a block, the block including a plurality of fields comprising least a recordkeeping procedure name, a first representative code for controlling creation and updating of a data file record, a second representative code for qualifying a digital value as a debit or credit, and a third representative code indicative of a document generated in connection with the accountable transaction immutably stored by a control code file structure of the at least one recordkeeping device;
creating, by the at least one authorization device, a digital signature for the block using at least one public/private key pair wherein a private key of the at least one public/private key pair is known only by the authorization device, and a public key of the at least one public/private key pair is known by the recordkeeping device;
updating, by the at least one authorization device, the plurality of fields in the block for storing the digital signature;
storing, by a ledger account data file management structure of the recordkeeping device, an account record corresponding to at least one of the one or more ledger accounts, the account record including the at least one value balance, the first representative code from a selected accounting control record of the accounting control records, and the second representative code from the selected accounting control record for qualifying the at least one value balance;
storing, by a transaction data file management structure of the recordkeeping device, a transaction record relating to the accountable transaction, the transaction record including at least the first representative code from the selected accounting control record, a digital value, the second representative code from the selected accounting control record for qualifying the digital value, and the third representative code from the selected accounting control record;
transferring, by a transaction data recording structure of the recordkeeping device, the transaction data including the digital value from the input structure and the first, second, and third representative codes from the selected accounting control record to a selected transaction record in the transaction data file structure; and
broadcasting, by a ledger account record broadcasting structure of the recordkeeping device, responsive to the third representative code at least one of the digital value and the at least one value balance from the selected transaction record to the account record for the ledger account affected by the accountable transaction,
wherein the at least one of the digital value and the at least one value balance are broadcasted on a Blockchain network,
wherein the Blockchain network comprises a plurality of the recordkeeping devices, a plurality of the authorization devices, and a plurality of the blocks,
wherein the blocks of the plurality of the blocks are associated with one another,
wherein each one of the blocks contains the digital signature from the authorization device, and
wherein at least one of the one or more ledger accounts and the transaction data can be maintained in at least one of the recordkeeping device, the authorization device, and the Blockchain network.

14. The method according to claim 13, wherein the recordkeeping device is a bookkeeping device.

15. The method according to claim 13, wherein the authorization device is a signing device.

16. The method according to claim 13, wherein the recordkeeping device and the authorization device are distinct from one another.

17. The method according to claim 13, wherein the recordkeeping device and the authorization device are the same.

18. The method according to claim 13, wherein the document generated in connection with the accountable transaction is any one of a balance sheet, an income statement, a cash flow statement, a statement of returned earnings, a statement of retained earnings, a statement of changes in equity, a statement of changes in notes, a projection report, a simulation report, a modelling report, a regulatory report, an assumption report, a sales report, a ledger file, a control general ledger file, a subsidiary ledger file, an obligation due subsidiary ledger file, a discretionary subsidiary ledger file, a temporary transaction records file, and a permanent transaction records file.

19. The method according to claim 13, wherein the authorization device further comprises the ledger account data file management structure, the transaction data file management structure, the transaction data recording structure, and the ledger account record broadcasting structure.

20. The method according to claim 13, wherein the recordkeeping device is arranged to generate the block including the plurality of fields, create the digital signature for the block using the at least one public/private key pair, and update the plurality of fields in the block for storing the digital signature.

21. The method according to claim 13, wherein the Blockchain network further comprises a preselected plurality of additional authorization devices, wherein each additional authorization device of the preselected plurality of additional authorization devices performs functions of the authorization device.

22. The method according to claim 13, further comprising one or more decision support technologies.

23. The method according to claim 22, wherein the one or more decision support technologies include business intelligence, artificial intelligence, machine learning, data mining, applied statistics, link analysis, mapping, visualization, analytics, predictive analytics, point-of-impact analytics, ratios, trends, Big Data, Decision Support Systems, neural networks, and enterprise resource management.

24. The method according to claim 13, wherein storing any one or more of the transaction record, the block including the plurality of fields, and the digital signature comprises putting the any one or more of the transaction record, the block including the plurality of fields, and the digital signature in one of a global data store, a local data store, a user-defined data store, the working area of an application execution environment, an audit trail, a versioned store, a full-text index, a directory, a relational database, an object database, a key-pair database, a filesystem, and a combination thereof.
